(19) United States
(12) Patent Application Publication
(10) Pub. No.: US 2018/0293509 A1
(43) Pub. Date: Oct. 11, 2018

(54) USER-BASED ONBOARDING

(71) Applicant: COURSERA, INC., Mountain View, CA (US)

(72) Inventor: Vaibhav SHARMA, Newark, CA (US)

(21) Appl. No.: 15/481,188

(22) Filed: Apr. 6, 2017

(51) Int. Cl. G06N 99/00; H04L 29/08; G06F 17/30

(52) U.S. Cl. CPC G06N 99/005; G06F 17/30312; H04L 67/22; H04L 67/02

(57) ABSTRACT

In one general aspect, a computer-implemented method can include gathering, by a computer system, indications of interactions of a user with a web application, storing, in a database included in the computer system, the gathered indications of interactions, identifying, by the computer system, at least one usage pattern for the web application based on the gathered indications of interactions of the user with the web application, determining whether the identified at least one usage pattern for the web application is an application event based usage pattern, and identifying suggested application event based content customization based on determining that the identified at least one usage pattern for the web application is an application event based usage pattern.

### TECHNICAL FIELD

This description generally relates to the use of behavioral data to provide an enhanced user experience.

### BACKGROUND

A web application can determine when and how to show particular content to a user. The web application can provide the particular content in a graphical user interface (GUI) of the web application. The content can help the user when navigating and interacting with the web application.

### SUMMARY

According to one general aspect, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a computer-implemented method can include gathering, by a computer system, indications of interactions of a user with a web application, storing, in a database included in the computer system, the gathered indications of interactions, identifying, by the computer system, at least one usage pattern for the web application based on the gathered indications of interactions of the user with the web application, determining whether the identified at least one usage pattern for the web application is an application event based usage pattern, and identifying suggested application event based content customization based on determining that the identified at least one usage pattern for the web application is an application event based usage pattern.

Implementations can include one or more of the following features, alone or in combination with one or more other features. For example, storing the gathered data can include storing the gathered indications of interactions in user data records included in the database in association with the user of the web application and in association with the web application. Gathering indications of interactions related to interactions of the user with the web application can be performed for a predetermined time period. The computer-implemented method can further include identifying suggested time-based content customization based on determining that the identified at least one usage pattern for the web application is not an application event based usage pattern. The computer-implemented method can further include providing a notification based on satisfying a specific time associated with the suggested time-based content customization. The computer-implemented method can further include identifying suggested context-based content customization based on determining that the identified at least one usage pattern for the web application is not an application event based usage pattern. The computer-implemented method can further include providing a notification based on satisfying a specific context associated with the suggested context-based content customization.

In another general aspect, a non-transitory, machine-readable medium has instructions stored thereon. The instructions, when executed by a processor, can cause a computing device to gather, by a data gathering application executing on the computing device, indications of interactions of a user with a natively operating application, store, in a memory included in the computing device, the gathered indications of interactions, identify, by the pattern learning application, at least one usage pattern for the natively operating application based on the gathered indications of interactions of the user with the natively operating application, determine whether the identified at least one usage pattern for the natively operating application is an application event based usage pattern, and identify, by the pattern learning application, suggested application event based content customization based on determining that the identified at least one usage pattern for the natively operating application is an application event based usage pattern.

Implementations can include one or more of the following features, alone or in combination with one or more other features. For example, the instructions that cause the computing device to store the gathered indications of interactions can include instructions that cause the computing device to store the gathered indications of interactions in association with the natively operating application. The instructions that cause the computing device to gather indications of interactions of the user with the natively operating application can be executed for a predetermined time period. The instructions can further include instructions that cause the computing device to identify suggested time-based content customization based on determining that the identified at least one usage pattern for the natively operating application is not an application event based usage pattern. The instructions can further include instructions that cause the computing device to provide a notification on the computing device based on satisfying a specific time associated with the suggested time-based content customization. The instructions can further include instructions that cause the computing device to identify suggested context-based content customization based on determining that the identified at least one usage pattern for the natively operating application is not an application event based usage pattern. The instructions can further include instructions that cause the computing device to provide a notification on the computing device based on satisfying a specific context associated with the suggested context-based content customization.

In yet another general aspect, a system can include a database including a plurality of user data records, a content customization module configured to receive content customization suggestions, a server data gathering application module, and a server pattern learning module. The server data gathering application module can be configured to gather indications of interactions of a user with a web application, and store the gathered indications of interactions in the database in association with the user data records. The server pattern learning module can be configured to identify at least one usage pattern for the web application based on the gathered indications of interactions of the user with the web application, determine whether the identified at least one usage pattern for the web application is an application event based usage pattern, identify suggested application event based content customization based on determining that the identified at least one usage pattern for the web application is an application event based usage pattern, and provide the suggested application event based content customization to the content customization module.

Implementations can include one or more of the following features, alone or in combination with one or more other features. For example, the server data gathering application module can be further configured to store the gathered indications of interactions in the user data records in association with the web application. The server pattern learning module can be further configured to identify suggested time-based content customization based on determining that the identified at least one usage pattern for the web application is not an application event based usage pattern, and provide the suggested time-based content customization to the content customization module. The content customization module can be further configured to provide a notification based on a specific time associated with the suggested time-based content customization being satisfied. The server pattern learning module can be further configured to identify suggested context-based content customization based on determining that the identified at least one usage pattern for the web application is not an application event based usage pattern, and provide the suggested context-based content customization to the content customization module. The content customization module can be further configured to provide a notification based on a specific context associated with the suggested context-based content customization being satisfied.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system that can provide user-based onboarding.

FIG. 2 is a block diagram of a flowchart showing an example method for implementing user-based onboarding.

FIG. 3 is a block diagram of a flowchart showing an example method for implementing user-based onboarding based on an application event based use pattern.

FIG. 4 is a block diagram of a flowchart showing an example method for implementing user-based onboarding based on a time-based and/or context-based use pattern.

FIG. 5 shows an example of a computer device and a mobile computer device that can be used to implement the techniques described here.

Like reference symbols in the various drawings indicate like elements.

### DETAILED DESCRIPTION

A web application can be enabled to (configured to) gather data and information related to how a user interacts with the web application. The web application can gather indications of interactions of a user with the web application. The indications of the interactions can be considered behavioral data. In some implementations, the behavioral data can be gathered over a particular timeframe. In some implementations, the behavioral data can be associated with an event that occurs related to the web application. A provider of the web application can provide methods and systems that can access the gathered data and information and use it to enhance the providing of the web application to the particular user. For example, a particular use pattern can be associated with an event. When the event occurs, based on the previous particular use pattern associated with the event, a specific GUI and associated behavior of the web application can be presented to the user. The user may not need to navigate through multiple web pages in order to reach the specific web page they want to interact with. Instead, the web page will initially be presented to the user based on the learned behavior. In another example, a particular use pattern can be identified as occurring over a particular period of time when a user is interacting with a web application. Based on the learned use pattern, a user can receive one or more notifications on a mobile computing device of the user at time that may be convenient or appropriate for a user to interact with the web application (even if the user may not currently be interacting with the web application). The notifications can indicate and recommend one or more ways for a user to interact with the web application based on a current state of the mobile device of the user. Based on the previously learned use pattern, the web application can behave in a particular manner (e.g., content may be presented in a particular way).

The presenting of content, web pages, and GUIs for a web application based on learned behavioral data for a user can enhance the user experience. For example, referring to an online course, a user (learner) can be enrolled in an online course. A previously learned use pattern can indicate that the majority of time the learner accesses the home page for the online course, they immediately then select the web page for the assignments. Based on this learned behavior (a previously learned use pattern), when a user accesses the home page for the online course in a web browser, the user can then be automatically routed to the web page for the assignments. In another example, over a ten day period of time, a learned use pattern indicates that a user (learner) accesses video(s) that present content and information for the online course. Based on this learned use pattern, a notification may be provided to a mobile device of the user when the mobile device detects movement. For example, the user (along with the mobile device) may be in a car traveling. In another example, the user may be walking with the mobile device. The notification may indicate how the user could listen to content and information for the online course using an audio feature for the online course application that can be included as part of the web application for the online course.

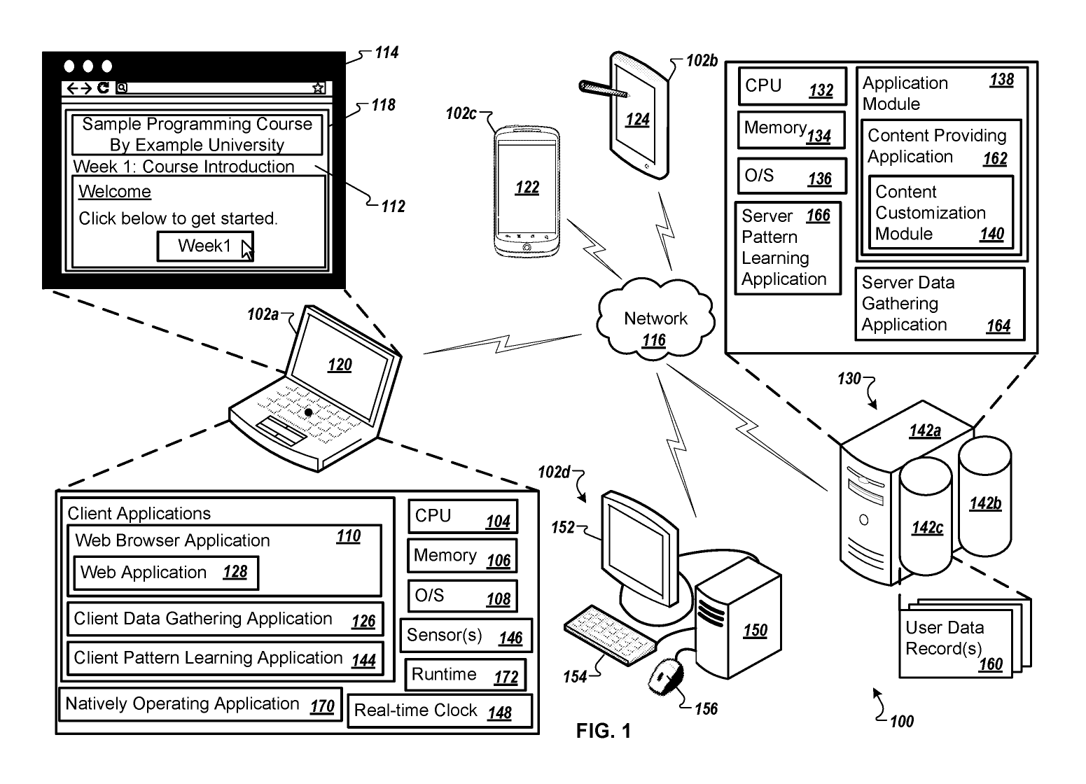

FIG. 1 is a diagram of an example system 100 that can provide user-based onboarding. The system 100 includes a plurality of computing devices 102a-d (e.g., a laptop or notebook computer, a tablet computer, a smartphone, and a desktop computer, respectively). The system 100 includes a computer system 130 that can include one or more computing devices (e.g., a server 142a) and one or more computer-readable storage devices (e.g., a database 142b and a database 142c).

An example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110 and a client-side data gathering application (e.g., a client data gathering application module 126). The web browser application 110 can execute one or more web applications (e.g., a web application 128). In some implementations, as shown in the example system 100, the client data gathering application module 126 can be an application included with other client applications that the computing device 102a can execute. In some implementations, the client data gathering application module 126 can be included in (be part of) a server data gathering application module 164. In some implementations, the client data gathering application module 126 can be included in (be part of) web application 128. The modules described herein can be implemented in hardware, firmware, and/or software.

The server 142a included in the computer system 130 can include one or more processors (e.g., a server CPU 132), and one or more memory devices (e.g., a server memory 134). The computing devices 102a-d can communicate with the computer system 130 (and the computer system 130 can communicate with the computing devices 102a-d) using a network 116. The server 142a can execute a server O/S 136. For example, the server 142a can provide content that can be included in (stored in) the database 142b and the database 142c, where the database 142b and he database 142c can be considered repositories. The server 142a can include an application module 138. The application module 138 can provide content (e.g., a video of an online course) to the computing devices 102a-d using the network 116.

In some implementations, the computing devices 102a-d can be laptop or desktop computers, smartphones, personal digital assistants, tablet computers, or other appropriate computing devices that can communicate, using the network 116, with other computing devices or computer systems. In some implementations, the computing devices 102a-d can perform client-side operations, as discussed in further detail herein. Implementations and functions of the system 100 described herein with reference to computing device 102a, may also be applied to computing device 102b, computing device 102c, and computing device 102d and other computing devices not shown in FIG. 1 that may also be included in the system 100.

The computing device 102a includes a display device 120. In some implementations, the display device 120 can be a touchscreen. The computing device 102b includes a display area 124 that can be a touchscreen. The computing device 102c includes a display area 122 that can be a touchscreen. The computing device 102d can be a desktop computer system that includes a desktop computer 150, a display device 152 that can be a touchscreen, a keyboard 154, and a pointing device (e.g., a mouse 156). A user can interact with one or more input devices and/or a touchscreen to hover over text or icons included in a user interface displayed on a display device.

In some implementations, the computer system 130 can represent more than one computing device working together to perform server-side operations. For example, though not shown in FIG. 1, the system 100 can include a computer system that includes multiple servers (computing devices) working together to perform server-side operations. In this example, a single proprietor can provide the multiple servers. In some cases, the one or more of the multiple servers can provide other functionalities for the proprietor.

In some implementations, the network 116 can be a public communications network (e.g., the Internet, cellular data network, dialup modems over a telephone network) or a private communications network (e.g., private LAN, leased lines). In some implementations, the computing devices 102a-d can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the web browser application 110 can execute or interpret a web application 128 (e.g., a browser-based application). The web browser application 110 can include a dedicated user interface (e.g., a web browser UI 114). The web application 128 can include code written in a scripting language, such as AJAX, JavaScript, VB Script, ActionScript, or other scripting languages. The web application 128 can display a web page 118 in the web browser UI 114. The web page 118 can include a graphical user interface (GUI) 112.

A natively operating application 170 can be an application that is coded using only web technology (defined here as code that can be implemented directly by a web browser application), such as JavaScript, ActionScript, HTML, or CSS. For example, the computing device 102a can download and install the natively operating application 170 from a marketplace server using a web browser application (e.g., the web browser application 110). The natively operating application 170 may operate using a runtime 172. The natively operating application 170 may be configured to be executed directly by the CPU 104 or by the O/S 108, using the runtime 172. Because the natively operating application 170 is coded using web technologies, no compilation step is required.

For example, a content providing application 162 included in the application module 138 can be launched. The content providing application 162 can retrieve content from the database 142b. The server 142a, using the network 116, can provide the content to the computing device 102a for use by the web application 128 and/or for use by the natively operating application 170.

In some implementations, the computing system 130 can execute a server-side server data gathering application (e.g., the server data gathering application module 164). The server data gathering application module 164 can receive data and information representative of interactions of a user (or learner) with the content. In addition, the server data gathering application module 164 can receive data and information representative of usage of the web application 128 by a user. For example, the server data gathering application module 164 can receive the data and information from the computing device 102a by way of the network 116.

In some implementations, the client data gathering application module 126 can receive data and information representative of interactions of a user (or learner) with the content. In addition, client data gathering application module 126 can receive data and information representative of usage of the web application 128 by a user.

As referred to herein, a data gathering application module can be the server data gathering application module 164 or the client data gathering application module 126. In some cases, the data and information received by a data gathering application module can be associated with or correlated with an event that can occur in the web application 128. In some cases, the data and information received by a data gathering application module can be associated with or correlated with an event that can occur in the natively operating application 170. Examples of an application event can include, but are not limited to, selection of a web page within the application, and selection of an option included in a GUI of the application. A data gathering application module can provide the data and information to the database 142c for storage in the user data record(s) 160.

In some cases, the data and information received by a data gathering application module can be time-based and/or context-based use and interaction data and information related to content provided to (received by) the computing device 102a for use by the web application 128. In some cases, the data and information received by a data gathering application module can be time-based and/or context-based use and interaction data and information related to content provided to (received by) the computing device 102a for use by the natively operating application 170. An example of time-based and/or context-based use and interaction data and information can be determining that a user (learner) accesses videos related to the content without using an audio feature for providing the content.

Sensor(s) 146 can provide context-based data and information. A real-time clock (RTC) 148 can provide time and date information (e.g., the time of day, the day of the week, etc.). The time and date information can be correlated with and/or related to content provided to the web application 128 and/or content provided to the natively operating application 170. The context-based data and information can be correlated with and/or related to content provided to the web application 128 and/or content provided to the natively operating application 170. For example, the sensor(s) 146 can detect the occurrence of certain events related to the use of the computing device 102a, such as changes in a physical orientation of the computing device 102a and/or changes in an ambient environment of the computing device 102a. In response to detecting the device-related events, the sensor(s) 146 can provide the data and information to the client data gathering application module 126 and /or to the server data gathering application module 164 about the detected device-related events. In some implementations, the client data gathering application module 126 can provide the context-based data and information to the server data gathering application module 164.

The server data gathering application module 164 can store the data and information about the detected events in association with the user and with content provided to the web application 128 and/or the natively operating application 170 in the database 142c (in the user data record(s) 160). In some implementations, in addition or alternatively, the client data gathering application module 126 can store the data and information about the detected events in association with content provided to the web application 128 and/or the natively operating application 170 in the memory 106.

The computing device 102a can execute a client-side client pattern learning application (e.g., a client pattern learning application module 144). The client pattern learning application module 144 can access data and information stored in the memory 106 to identify one or more usage patterns for a user of the computing device 102a. The client pattern learning application module 144 can provide the identified one or more usage patterns for a user to a content customization module 140 included in the content providing application 162 on the server 142a.

The computing system 130 can execute a server-side server pattern learning application (e.g., a server pattern learning application module 166). In some implementations, the server pattern learning application module 166 can access data and information included (stored) in the database 142c (and specifically stored in the user data record(s) 160) to identify one or more usage patterns for a user. The server pattern learning application module 166 can provide the identified one or more usage patterns for a user to the content customization module 140 included in the content providing application 162.

The content customization module 140 can provide one or more possible ways to provide content to a user based on the identified usage patterns for the user. For example, when the data and information received by the server data gathering application module 164 is associated with or correlated with an event that can occur in the web application 128, the content customization module 140 can provide a suggestion to the content providing application 162 to take a user (learner) to a specific web page when the user launches the web application 128. For example, when the data and information received by the server data gathering application module 164 is time-based and/or context-based use and interaction data and information related to content provided to (received by) the computing device 102a for use by the web application 128, the content customization module 140 can provide a suggestion to the content providing application 162 to provide notifications to a user at a particular time based on past interactions with content in a particular format.

The sensor(s) 146 can include, but are not limited to, a gyrometer (gyroscope), accelerometer(s), a light sensor, a temperature sensor, a location sensor(s), biosensor(s), environment sensor(s), motion sensor(s), proximity sensor(s), and touch sensor(s). The gyrometer can detect changes in a physical orientation of the computing device 102a (e.g., between a vertical orientation and a horizontal orientation). The gyrometer can determine the roll, pitch and yaw of the computing device 102a. The accelerometer(s) can detect changes in vibrations, or patterns of vibrations occurring in an ambient environment of the computing device 102a. Footsteps of a person or persons walking near the computing device 102a or movement of the computing device 102a may cause the vibrations. The light sensor can detect changes in a measured light intensity in the ambient environment of the computing device 102a. The temperature sensor can detect changes in a measured temperature in the ambient environment of the computing device 102a. The location sensor(s) can detect changes in a physical location of the computing device 102a, such as may occur if a user is traveling with the computing device 102a. In some implementations, the location sensor(s) can include a global positioning system (GPS). The biosensor(s) can include, but are not limited to, fingerprint sensors, heart rate sensors, glucose sensors, and odor detectors or sensors. The environment sensor(s) can include, but are not limited to, an altimeter, a barometer, a relative humidity sensor, and a step sensor. For example, the step detector may detect movement of a user of the computing device 102a (e.g., the user is walking with the computing device 102a). The proximity sensor(s) can include one or more sensors capable of determining a proximity of a user to the computing device 102a without the user needing to physically contact the computing device 102a. Example proximity sensors can include, but are not limited to, capacitive sensors, inductive sensors, ultrasonic sensors, and infrared sensors. The touch sensor(s) can include one or more sensors capable of detecting a physical contact (e.g., touching, holding, squeezing) of a user with the computing device 102a.

For example, the computing device 102a can receive a video of an online video course from the computer system 130. For example, the web application 128 can display in the web browser UI 114 one or more icons representative of (associated with) respective one or more courses for selection by a user of the computing device 102a. For example, the user can select a course by placing a cursor on an icon. The user can then select the icon (e.g., click a mouse button). The selection of the icon can launch the online course. When launched, the computer system 130 can provide the video of the online course. The display device 120 can display the visual content of the video of the online course and one or more speakers (not shown) included in the computing device 102a can play the audio portion of the online course.

For example, the content providing application 162 included in the application module 138 can be launched. The content providing application 162 can retrieve a video of an online course from the database 142b. The server 142a using the network 116 can provide the video of the online course to the computing device 102a. The server data gathering application module 164 can receive data and information representative of interactions of a user (or learner) with the online course. The server data gathering application module 164 can provide the data and information to the database 142c for storage in user data record(s) 160.

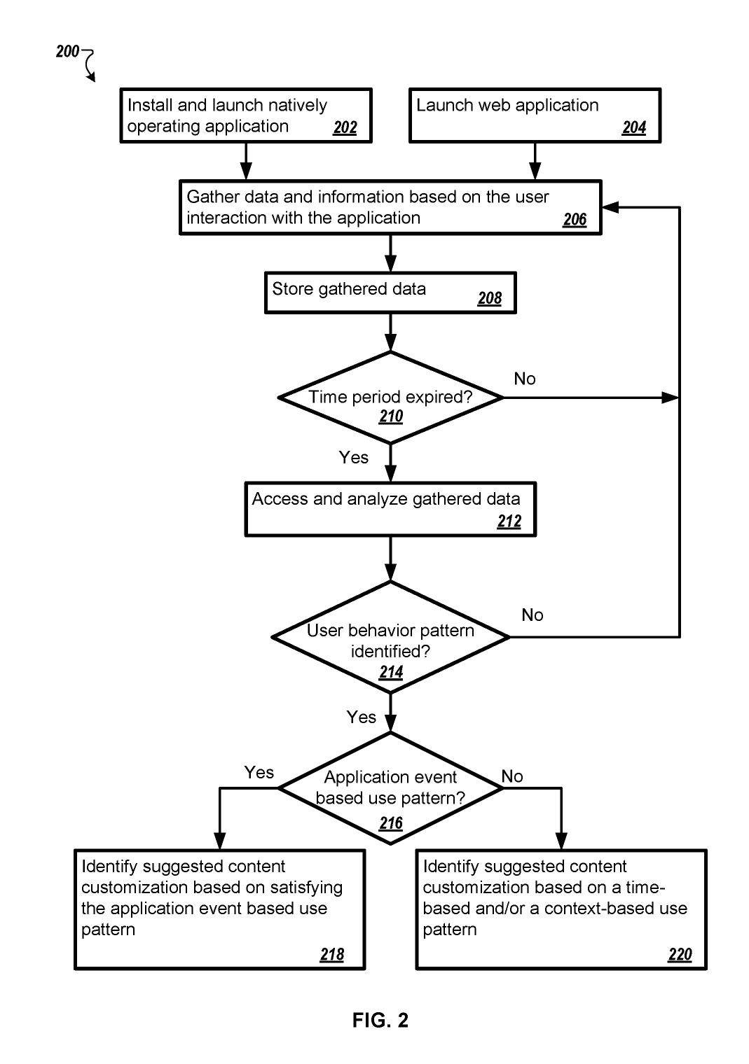

FIG. 2 is a block diagram of a flowchart showing an example method 200 for implementing user-based onboarding. In some implementations, the systems and processes described herein can implement the method 200. For example, the method 200 can be described referring to FIG. 1. In addition, the method 200 can be described for an example of the system 100 that provides an online course to a learner.

A natively operating application can be installed and launched (block 202). For example, the natively operating application 170 can be received from the computer system 130. The natively operating application 170 can be downloaded and installed on the computing device 102a. In another example, as described with reference to FIG. 1, the computing device 102a can download and install the natively operating application 170 from a marketplace server using the web browser application 110. Alternatively, a web application can be launched (block 204). For example, the web application 128 can be launched and run within the web browser application 110. The application module 138 can provide the web application 128.

Data and information based on (related to) interactions of a user with the application (the web application and/or the natively operating application) can be gathered (block 206). The data and information can be indications of interactions of a user with the application. For example, the client data gathering application module 126 can monitor user interactions with the natively operating application 170. The client data gathering application module 126 can gather indications of user interactions with the natively operating application 170. Referring to FIG. 1, though shown as a separate application, in some implementations the client data gathering application module 126 can be included as part of the natively operating application 170. In another example, in the case where the application is a web application (e.g., the web application 128), the server data gathering application module 164 can monitor user interactions with the web application 128. The server data gathering application module 164 can gather indications of user interactions with the web application 128. For example, the web application and/or the natively operating application can be an application that can provide online courses.

The gathered data is stored (block 208). For example, the client data gathering application module 126 can store the gathered data and information in the memory 106. The gathered data and information is stored in association with the natively operating application 170. For example, the server data gathering application module 164 can store the gathered data and information in the database 142c, and specifically in the user data record(s). The gathered data is stored in association with the user of the computing device 102a and in association with the web application 128 executing on the computing device 102a.

It is determined if a time period has expired (block 210). If the time period has not expired, the method 200 continues to gather data and information based on user interactions with the application (block 206). For example, the method 200 can continue to gather data and information about user interactions for a period of time (e.g., 24 hours, one week, one month). If the time period has expired, the gathered data and information is accessed and analyzed (block 212). For example, the client pattern learning application module 144 can access the memory 106 and analyze the data and information related to user interactions with the natively operating application 170 where the user is a user of the computing device 102a. For example, the server pattern learning application module 166 can access the user data record(s) and analyze the data and information related to user interactions with the web application 128 where the user is a user of the computing device 102a.

It is determined if any user behavior pattern is identified (block 214). For example, the client pattern learning application module 144, based on the analysis of the gathered data and information related to interactions of a user with the natively operating application 170, can identify one or more usage patterns for a user of the computing device 102a when interacting with the natively operating application 170. For example, the server pattern learning application module 166, based on the analysis of the gathered data and information related to interactions of a user with the web application 128, can identify one or more usage patterns for a user of the computing device 102a when interacting with the web application 128.

If it is determined that at least one user behavior pattern is not identified, the method 200 continues to gather data and information based on user interactions with the application (block 206). If it is determined that at least one user behavior pattern is identified, it is then determined if the identified user behavior pattern is an application event based use pattern (block 216).

If it is determined that the identified user behavior pattern is an application event based use pattern, suggested content customization is identified based on satisfying the application event based use pattern (block 218). For example, the suggested content customization can be provided to the content providing application 162 (and in particular the content customization module 140) based on an identified application event based use pattern. If it is determined that the identified user behavior pattern is not an application event based use pattern (e.g., the identified user behavior pattern is a time-based and/or context-based use pattern), suggested content customization is identified based on a time-based and/or a context-based use pattern (block 220). For example, the suggested content customization can be provided to the content providing application 162 based on the time-based and/or context-based user behavior use pattern. In some implementations, the natively operating application 170 can provide the content customization needed.

In an example for an online course, the web application 128 and the natively operating application 170 can be applications for an online course provider. A user of the computing device 102a can interface with a GUI provided by the natively operating application 170 when interacting with content provided for online courses.

The web application 128 and/or the natively operating application 170 can provide content for online course that can include, but is not limited to, video lectures, online forums, online assignments, online quizzes, online tests, and an online textbook. The gathered data and information based on interactions of a user (learner) with the web application 128 and/or the natively operating application 170 can include, but is not limited to, web pages accessed by the learner, video lectures accessed by the learner, online forums the user has participated in, assignments, quizzes, and tests accessed and completed by the learner, and use of the online textbook by the user. The data and information gathered can include URLs, date and time of accesses, frequency of accesses, and any preferences for interacting with the online course set by the learner.

For example, an identified application event based use pattern can be that a when a user launches an online course that they are enrolled in, they immediately access the assignment UI for the online course. Based on identifying this particular usage pattern, the content can be customized for the user such that when the user launches the online course that they are enrolled in, rather than launching a home web page for the online course, an assignment web page that includes the assignment UI will be launched. This can provide a more positive user experience with the online course because the user does not need to access (click through) multiple web pages in order to get to the assignment web page.

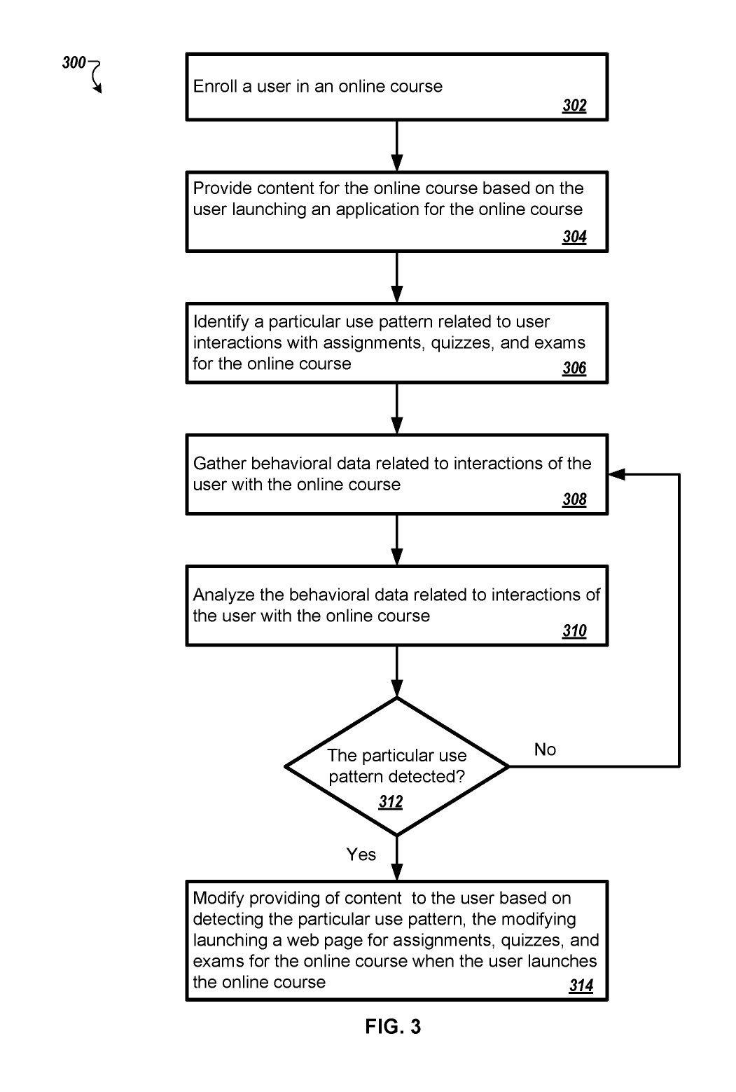

FIG. 3 is a block diagram of a flowchart showing an example method 300 for implementing user-based onboarding for an online course provider based on an application event based use pattern. In some implementations, the systems and processes described herein can implement the method 300. For example, the method 300 can be described referring to FIG. 1. In addition, the method 300 can be described for an example of the system 100 that provides an online course to a learner.

A user is enrolled in an online course (block 302). For example, a user can interface with the natively operating application 170 and/or the web application 128 to select and enroll in an online course. Content for the online course is provided based on the user launching an application for the online course (block 304). For example, the content providing application 162 can provide the course content to the natively operating application 170 and/or the web application 128. A particular use pattern related to user interactions with assignments, quizzes, and exams for the online course is identified (block 306). For example, the server pattern learning application module 166 and/or the client pattern learning application module 144 can determine that particular user interactions with assignments, quizzes, and exams for the online course can be identified as a particular predefined usage pattern.

Behavioral data related to interactions of the user with the online course is gathered (block 308). The behavioral data can include indications of interactions of a user with the application for the online course. The behavioral data related to interactions of the user with the online course is analyzed (block 310). If the particular use pattern is detected (block 312), the providing of content to the user is modified based on detecting the particular use pattern, the modifying launching a web page for assignments, quizzes, and exams for the online course when the user launches the online course (block 314). If the particular use pattern is not detected (block 312), the method 300 continues to gather behavioral data related to interactions of the user with the online course (block 308).

When analyzing data and information for a user based on interactions with the web application 128, the server pattern learning application module 166 can look for usage patterns that match (or closely line up with) the predefined usage pattern. Based on a match, the server pattern learning application module 166 can provide the content customization module 140 a suggested content customization when the content providing application 162 provides content to the web application 128. The suggested content customization can provide for a more fulfilling user experience with the web application 128. When analyzing data and information for a user based on interactions with the natively operating application 170, the client pattern learning application module 144 can look for usage patterns that match (or closely line up with) the predefined usage pattern. Based on a match, the client pattern learning application module 144 can provide the content customization module 140 a suggested content customization when the content providing application 162 provides content to the natively operating application 170. In some implementations, a content customization module can be included in natively operating application 170. The suggested content customization can provide for a more fulfilling user experience with the natively operating application 170.

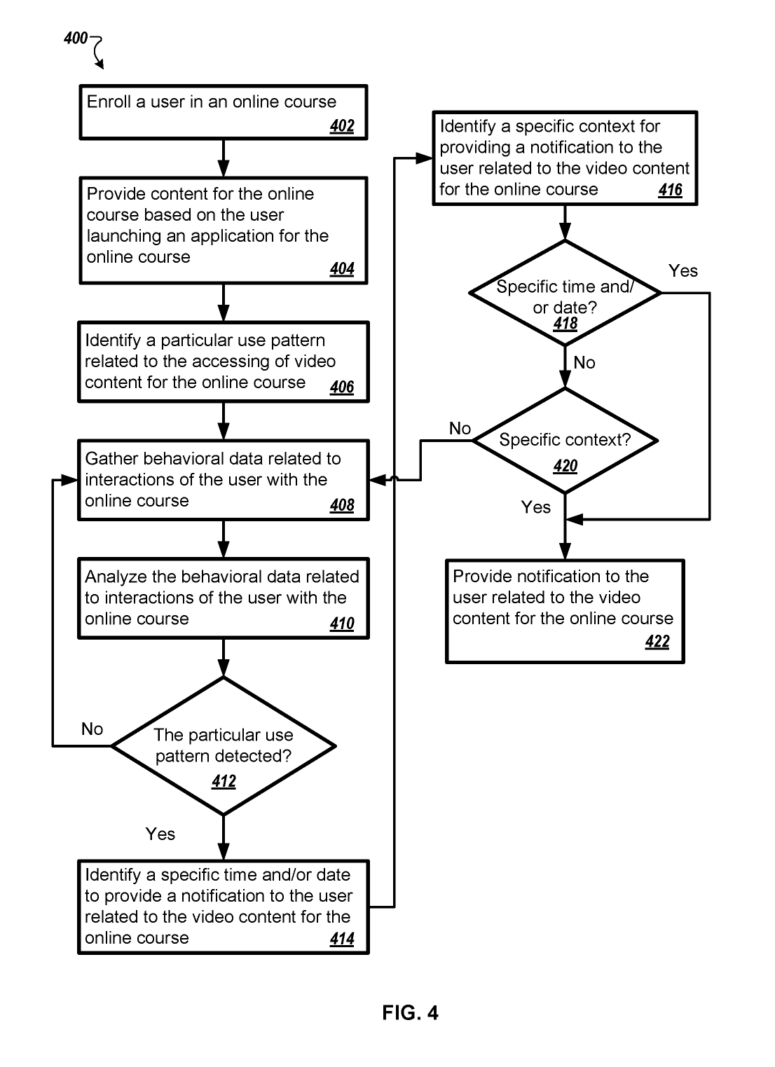

FIG. 4 is a block diagram of a flowchart showing an example method 400 for implementing user-based onboarding for an online course provider based on a time-based and/or context-based use pattern. In some implementations, the systems and processes described herein can implement the method 400. For example, the method 400 can be described referring to FIG. 1. In addition, the method 400 can be described for an example of the system 100 that provides an online course to a learner.

A user is enrolled in an online course (block 402). For example, a user can interface with the natively operating application 170 and/or the web application 128 to select and enroll in an online course. Content for the online course is provided based on the user launching an application for the online course (block 404). For example, the content providing application 162 can provide the course content to the natively operating application 170 and/or the web application 128. A particular use pattern related to the accessing of video content for the online course is identified (block 406). For example, the server pattern learning application module 166 and/or the client pattern learning application module 144 can determine that a user watches lecture videos in the natively operating application 170 and/or the web application 128, respectively, for the online course. The watching of the lecture videos can be identified as a particular predefined usage pattern.

Behavioral data related to interactions of the user with the online course is gathered (block 308). The behavioral data can include indications of interactions of a user with the application for the online course. The behavioral data related to interactions of the user with the online course is analyzed (block 410). If the particular use pattern is not detected (block 412), the method 400 continues to gather behavioral data related to interactions of the user with the online course (block 408). If the particular use pattern is detected (block 412), a specific time and/or date to provide a notification to the user related to the video content for the online course is identified (block 414). A specific context for providing a notification to the user related to the video content for the online course is identified (block 416).

It is determined if the identified specific time and/or date to provide a notification to the user related to the video content for the online course has been satisfied (has occurred) (block 418). If it is determined that the identified specific time and/or date has not been satisfied (has not occurred), it is determined if the identified specific context for providing a notification to the user related to the video content for the online course has been satisfied (block 420). If it is determined that the identified specific context has not been satisfied, the method 400 continues to gather behavioral data related to interactions of the user with the online course (block 408).

If it is determined that the identified specific time and/or date has been satisfied (has occurred) (block 418), a notification is provided to the user that is related to the video content for the online course (block 422). If it is determined that the identified specific context has been satisfied (block 420), a notification is provided to the user that is related to the video content for the online course (block 422).

When analyzing data and information for a user based on interactions with the web application 128, the server pattern learning application module 166 can look for usage patterns that match (or closely line up with) the predefined usage pattern. Based on a match, the server pattern learning application module 166 can provide the content customization module 140 with suggestions for notifications to provide a learner based on the predefined usage pattern. For example, if a learner watches lecture videos on weekday evenings, if a learner has not accessed a lecture video after a period of time (e.g., a few days, a week) the server pattern learning application module 166 can provide the content customization module 140 with a suggestion to provide the learner with a notification at the identified specific time and/or date (e.g., 9:00 pm on Monday Dec. 12, 2016). The notification can be provided to one or more computing devices that a learner may use to access the online course. For example, the content customization module 140 can provide a notification to a mobile device of the user. In another example, the content customization module 140 can provide a notification to the learner by way of a forum for the online course.

In another example, if a learner watches lecture videos a learner may be interested in using a background audio feature provided by the online course provider to listen to the online lectures. The server pattern learning application module 166 can provide the content customization module 140 with a suggestion to provide the learner with a notification when a particular context of the learner would be conducive to listening to an audio lecture. For example, referring to FIG. 1, the one or more sensor(s) 146 included on the computing device 102a can provide an indication that the computing device 102a is in motion implying that the learner may be walking, riding in a car, sitting on a train, etc. In these contexts, the learner may want to use the background audio feature to listen to an online lecture. The notification can be provided to the computing device 102a. The learner can then use the background audio feature to listen to an online lecture.

Though described for the web application 128, the natively operating application 170 and the client pattern learning application module 144 can also look for usage patterns that match (or closely line up with) the predefined usage pattern. Based on a match, the client pattern learning application module 144 can also provide the content customization module 140 a notification suggestion.

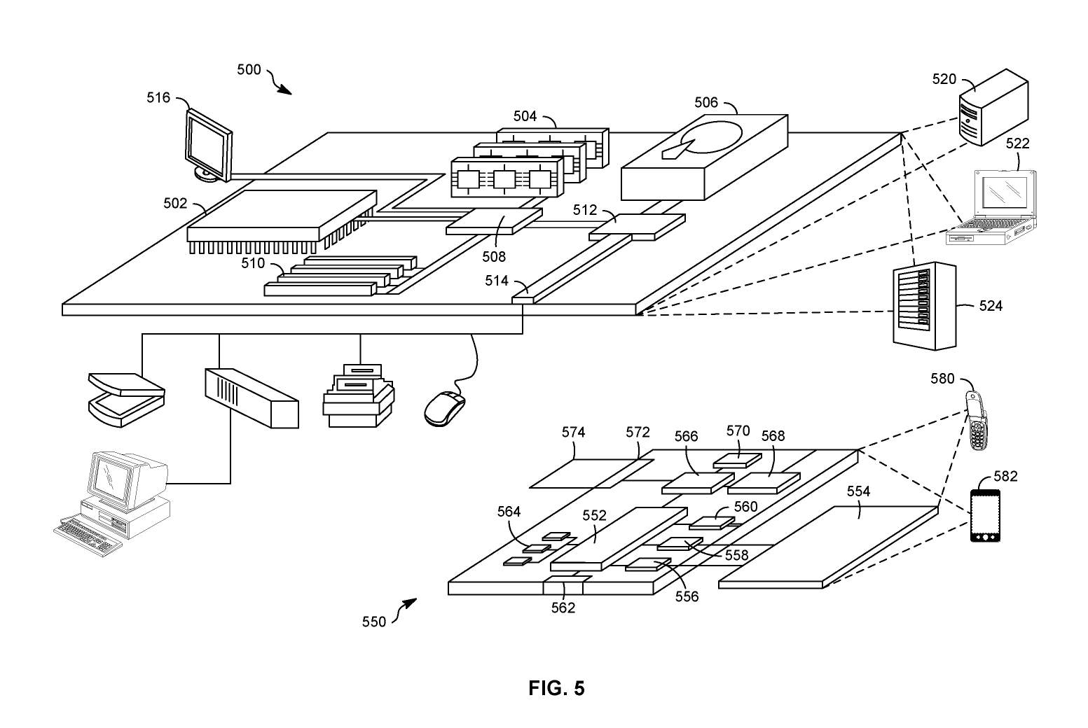

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
gathering, by a computer system, indications of interactions of a user with a web application;
storing, in a database included in the computer system, the gathered indications of interactions;
identifying, by the computer system, at least one usage pattern for the web application based on the gathered indications of interactions of the user with the web application;
determining whether the identified at least one usage pattern for the web application is an application event based usage pattern; and
identifying suggested application event based content customization based on determining that the identified at least one usage pattern for the web application is an application event based usage pattern.

2. The method of claim 1, wherein storing the gathered data includes storing the gathered indications of interactions in user data records included in the database in association with the user of the web application and in association with the web application.

3. The method of claim 1, wherein gathering indications of interactions of the user with the web application is performed for a predetermined time period.

4. The method of claim 1, further comprising identifying suggested time-based content customization based on determining that the identified at least one usage pattern for the web application is not an application event based usage pattern.

5. The method of claim 4, further comprising providing a notification based on satisfying a specific time associated with the suggested time-based content customization.

6. The method of claim 1, further comprising identifying suggested context-based content customization based on determining that the identified at least one usage pattern for the web application is not an application event based usage pattern.

7. The method of claim 6, further comprising providing a notification based on satisfying a specific context associated with the suggested context-based content customization.

8. A non-transitory, machine-readable medium having instructions stored thereon, the instructions, when executed by a processor, cause a computing device to:
gather, by a data gathering application executing on the computing device, indications of interactions of a user with a natively operating application;
store, in a memory included in the computing device, the gathered indications of interactions;
identify, by the pattern learning application, at least one usage pattern for the natively operating application based on the gathered indications of interactions of the user with the natively operating application;
determine whether the identified at least one usage pattern for the natively operating application is an application event based usage pattern; and
identify, by the pattern learning application, suggested application event based content customization based on determining that the identified at least one usage pattern for the natively operating application is an application event based usage pattern.

9. The medium of claim 8, wherein the instructions that cause the computing device to store the gathered indications of interactions include instructions that cause the computing device to store the gathered indications of interactions in association with the natively operating application.

10. The medium of claim 8, wherein the instructions that cause the computing device to gather indications of interactions of the user with the natively operating application are executed for a predetermined time period.

11. The medium of claim 8, wherein the instructions further comprise instructions that cause the computing device to identify suggested time-based content customization based on determining that the identified at least one usage pattern for the natively operating application is not an application event based usage pattern.

12. The medium of claim 11, wherein the instructions further comprise instructions that cause the computing device to provide a notification on the computing device based on satisfying a specific time associated with the suggested time-based content customization.

13. The medium of claim 8, wherein the instructions further comprise instructions that cause the computing device to identify suggested context-based content customization based on determining that the identified at least one usage pattern for the natively operating application is not an application event based usage pattern.

14. The medium of claim 13, wherein the instructions further comprise instructions that cause the computing device to provide a notification on the computing device based on satisfying a specific context associated with the suggested context-based content customization.

15. A system comprising:
a database including a plurality of user data records;
a content customization module configured to receive content customization suggestions;
a server data gathering application module configured to:
gather indications of interactions of a user with a web application, and
store the gathered indications of interactions in the database in association with the user data records; and
a server pattern learning module configured to:
identify at least one usage pattern for the web application based on the gathered indications of interactions of the user with the web application,
determine whether the identified at least one usage pattern for the web application is an application event based usage pattern,
identify suggested application event based content customization based on determining that the identified at least one usage pattern for the web application is an application event based usage pattern, and
provide the suggested application event based content customization to the content customization module.

16. The system of claim 15, wherein the server data gathering application module is further configured to store the gathered indications of interactions in the user data records in association with the web application.

17. The system of claim 15, wherein the server pattern learning module is further configured to:
identify suggested time-based content customization based on determining that the identified at least one usage pattern for the web application is not an application event based usage pattern, and
provide the suggested time-based content customization to the content customization module.

18. The system of claim 17, wherein the content customization module is further configured to provide a notification based on a specific time associated with the suggested time-based content customization being satisfied.

19. The system of claim 15, wherein the server pattern learning module is further configured to:
identify suggested context-based content customization based on determining that the identified at least one usage pattern for the web application is not an application event based usage pattern, and
provide the suggested context-based content customization to the content customization module.

20. The system of claim 19, wherein the content customization module is further configured to provide a notification based on a specific context associated with the suggested context-based content customization being satisfied.
